(19) United States
(12) Patent Application Publication
(10) Pub. No.: US 2005/0222344 A1
(43) Pub. Date: Oct. 6, 2005

(54) Process for producing water-absorbing polymer having controlled moisture content

(75) Inventors: Shinichi Kondo, Tokyo (JP); Kazuhiro Hikida, Tokyo (JP)

Correspondence Address: BIRCH STEWART KOLASCH & BIRCH, PO BOX 747, FALLS CHURCH, VA, 22040-0747, US

(73) Assignee: ZEON CORPORATION

(21) Appl. No.: 11/092,659

(22) Filed: Mar. 30, 2005

(30) Foreign Application Priority Data
Mar. 31, 2004 (JP) 2004-106344

(51) Int. Cl. C08F 8/00

(52) U.S. Cl. 525/333.8

(57) ABSTRACT

A water-absorbing polymer having a desirably controlled moisture content with a reduced variability from lot to lot and suitable for a shaped article having good characteristics is obtained by bringing a finely divided particle of water-absorbing polymer into contact with a stream of air having a moisture content of 2-20 g/m³ so that the moisture content in the polymer particle is increased by 300 ppm by weight or more to a moisture content of 300-50,000 ppm by weight. This moisture content-controlling treatment is carried out using a closed vessel wherein the air is fed, or using a pneumatic transportation apparatus wherein the air is fed, and the transportation and moisture content-control of polymer particle are conducted simultaneously.

### BACKGROUND OF THE INVENTION

(1) Field of the Invention

This invention relates to a process for producing a water-absorbing polymer having a controlled moisture content. More particularly, it relates to a process for producing a water-absorbing polymer having a controlled moisture content varying from lot to lot only to a reduced extent and suitable for shaped articles exhibiting good characteristics.

(2) Description of the Related Art

As a water-absorbing polymer, many polymers are known which include, for example, polyacrylic acid salts, polyvinyl alcohol, polyacrylamides and polyoxyethylenes. These water-absorbing polymers are used in various fields wherein their characteristics are utilized.

In many cases, water-absorbing polymers are required to have a moisture content controlled within a predetermined range in view of the characteristics desired for the final applications, good processability required for processing, and good handling characteristics.

For example, a polyoxyethylene polymer is suitable for an OA roll, and, for this application, the polymer is required to have a volume resistivity and other properties, which have a reduced variability from lot to lot only to a minor extent. For this requirement, the polymer preferably have a moisture content controlled within a limited range. Further, a polyoxyethylene polymer is often blended with another resin for use in various fields. In the case when the polymer has a large moisture content, when finely divided particles of the polymer are placed in a mixer, the finely divided particles are liable to stick to each other. Thus, the handling characteristics are poor.

### SUMMARY OF THE INVENTION

An object of the present invention is to provide a process for producing a water-absorbing polymer having a desirably controlled moisture content, which varies from lot to lot (or from batch to batch) only to a minimized extent and is suitable for a shaped article exhibiting good characteristics.

Thus, in one aspect of the present invention, there is provided a process for producing a water-absorbing polymer having a controlled moisture content, characterized in that a finely divided particle of a water-absorbing polymer is brought into contact with a stream of air having a moisture content in the range of 2 to 20 g/m³ in a closed vessel so that the moisture content in the finely divided particle of polymer is increased by 300 ppm by weight or more to a moisture content in the range of 300 ppm to 50,000 ppm by weight.

In another aspect of the present invention, there is provided a process for producing a water-absorbing polymer having a controlled moisture content, characterized in that a pressurized air having a moisture content in the range of 2 to 20 g/m³ is fed into a transportation chamber of a pneumatic transportation apparatus where a finely divided particle of a water-absorbing polymer is brought into contact with a stream of the air while the finely divided particle of polymer is transported through the transportation chamber, so that the moisture content in the finely divided particle of polymer is increased by 300 ppm by weight or more to a moisture content in the range of 300 ppm to 50,000 ppm by weight.

In a further aspect of the present invention, there is provided a process for producing a water-absorbing polymer having a controlled moisture content, characterized in that a finely divided particle of a water-absorbing polymer is dried to a moisture content which is at least 300 ppm by weight lower than a finally desired moisture content within the range of 300 ppm to 50,000 ppm by weight; and then, the dried finely divided particle of polymer is brought into contact with a stream of air having a moisture content in the range of 2 to 20 g/m³ so that the moisture content in the finely divided particle of polymer is increased by 300 ppm by weight or more to the finally desired moisture content within the range of 300 ppm to 50,000 ppm by weight.

According to the present invention wherein a finely divided particle of a water-absorbing polymer (hereinafter referred to as “water-absorbing polymer particle” or “polymer particle” when appropriate) is brought into contact with a stream of air having a moisture content of 2 to 20 g/m³ so that the moisture content in the water-absorbing polymer particle is increased by 300 ppm by weight or more to a moisture content of 300 ppm to 50,000 ppm by weight, a water-absorbing polymer having a desirably controlled moisture content with a reduced variability from lot to lot (or from batch to batch) can be produced. A shaped article of the water-absorbing polymer is characterized as having a volume resistivity and other properties with a reduced variability from lot to lot.

When a finely divided particle of a polyether polymer comprising as the principal structural ingredient oxyalkyene repeating units formed by ring-opening polymerization of at least one kind of oxirane monomer is subjected to a moisture content-controlling treatment according to the process of the present invention, a polyether polymer having a volume resistivity with a reduced variability from lot to lot can be obtained. Therefore the polyether polymer is suitable especially for an OA (office automation) roll. The polyether polymer exhibits reduced stickiness at handling and thus has good handling characteristics.

### DESCRIPTION OF THE PREFERRED EMBODIMENTS

In the present invention, a water-absorbing polymer particle is treated so that the moisture content in the polymer particle is increased by 300 ppm by weight or more to a desired moisture content in the range of 300 ppm to 50,000 ppm by weight.

By the term “water-absorbing polymer” as used herein, we mean a polymer exhibiting a water absorption of at least 10% by weight as measured by the following method.

A polymer is molded by injection molding into a flat plate having a size of 65 mm×65 mm×3 mm. The plate [weight: (a)] is immersed in a bath of ion-exchanged water at 23° C. for one week. The plate is then taken from the aqueous bath, and is wiped to remove water from the surface. Then the plate is weighed [weight: (b)]. The water absorption (%) is expressed by a weight increase (%) calculated by the following equation.
Weight increase (%)=[(b)−(a)]/(a)×100
where (a): weight of plate as measured before immersion in water

(b): weight of plate as measured after immersion in water

In the case when a polymer has a strong adsorption and, when a polymer plate is immersed in water, the plate readily absorbs a large amount of water, and exhibits too large stickiness to measure the water absorption, there is no need of measuring the water absorption. This polymer can be recognized as a water-absorbing polymer as used in the present invention.

By the term “finely divided particle” as used herein, we mean particles having an average diameter in the range of 10 μm to 2,000 μm.

As examples of the water-absorbing polymer, there can be mentioned polyacrylic acid salts, polyvinyl alcohol, polyacrylamides and polyoxyethylenes (i.e., polyether polymers). Of these, polyether polymers are especially suitable for giving a polymer having a desired moisture content and having good characteristics suitable for, for example, an OA roll.

The polyether polymer will now be described in detail.

The polyether polymer comprises as the principal structural ingredients oxyalkylene repeating units formed by ring-opening polymerization of at least one kind of oxirane monomer. The oxirane monomer used is not particularly limited, but is preferably an ethylene oxide monomer (a). That is, a polyether polymer comprising as the principal structural ingredient ethylene oxide repeating units (A) formed by ring-opening polymerization of an ethylene oxide monomer (a) is preferably used. A polyether polymer comprising, based on the total repeating units, 70% to 99% by mole of ethylene oxide repeating units (A) and 1% to 30% by mole of repeating units (B) of other oxirane monomer (b) copolymerizable with an ethylene oxide monomer (a) is more preferably used.

The content of ethylene oxide monomer units (A) in the polyether polymer is more preferably in the range of 80% to 98% by mole, and especially preferably 90% to 97% by mole. The content of oxirane monomer units (B) in the polyether polymer is more preferably in the range of 2% to 20% by mole, and especially preferably 3% to 10% by mole.

The oxirane monomer (b) used for copolymerization with an ethylene oxide monomer (a) for forming the oxirane monomer units (B) includes, for example, alkylene oxides having 3 to 20 carbon atoms, glycidyl ethers having 1 to 10 carbon atoms, and oxides of vinyl compounds.

As specific examples of the alkylene oxides having 3 to 20 carbon atoms, there can be mentioned chainlike alkylene oxides such as propylene oxide, 1,2-epoxybutane, 1,2-epoxyisobutane, 2,3-epoxybutane, 1,2-epoxyhexane, 1,2-epoxyoctane, 1,2-epoxydecane, 1,2-epoxytetradecane, 1,2-epoxyhexadecane, 1,2-epoxyoctadecane and 1,2-epoxyeicosane; and cycloalkylene oxides such as 1,2-epoxycyclopentane, 1,2-epoxycyclohexane and 1,2-epoxycyclododecane. As specific examples of the glycidyl ethers having 1 to 10 carbon atoms, there can be mentioned alkyl glycidyl ethers such as methyl glycidyl ether, ethyl glycidyl ether and butyl glycidyl ether; and aryl glycidyl ethers such as phenyl glycidyl ether. As specific examples of the oxides of vinyl compounds, there can be mentioned styrene oxide. Of these, chainlike alkylene oxides are preferable. Propylene oxide and 1,2-epoxybutane are especially preferable because they have high polymerizability. These oxirane monomers may be used either alone or as a combination of at least two kinds thereof.

As the oxirane monomers (b), diepoxy compounds may be used in combination with the above-recited oxirane monomers. The diepoxy compounds include, for example, vinylcyclohexene dioxide, butadiene dioxide, ethylene glycol diglycidyl ether and polyethylene glycol diglycidyl ether. When a diepoxy compound is used in combination with the above-recited oxirane monomers, the resulting oxyane monomer units (B) have a branched structure. When a diepoxy compound is used, the amount thereof is preferably in the range of 0.1% to 5% by mole based on the total of the oxirane monomers (b) and the ethylene oxide monomer (a).

In the case when a crosslinked polyether polymer is prepared, an oxirane monomer (c) having a crosslink-forming functional group (said oxirane monomer is hereinafter referred to as “crosslinking oxirane monomer (c)”) is preferably used as a part of the above-recited oxirane monomer (b). The crosslink-forming functional group means a functional group capable of forming a crosslinked structure when it is heated or irradiated with active radiation. When a crosslinking oxirane monomer is used as a part of the above-recited oxirane monomer (b), crosslinks can easily be formed in a resulting polyether polymer, and thus, a shaped article having a high strength can easily be obtained. In this case, the amount of crosslinking monomer (c) used is usually not larger than 15% by mole, preferably in the range of 1% to 9% by mole, based on the total oxirane monomers used for the preparation of the polyether polymer.

The crosslinking oxirane monomer (c) includes, for example, halogenated compounds of an epoxy compound, and epoxy compounds having a vinyl group. As specific examples of the halogenated compounds of an epoxy compound, there can be mentioned halogenated alkylene oxides such as epihalohydrins including, for example, epichlorohydrin and epibromohydrin; p-chlorostyrene oxide; and dibromophenyl glycidyl ether. As specific examples of the epoxy compounds having a vinyl group, there can be mentioned ethylenically unsaturated glycidyl ethers such as vinyl glycidyl ether and allyl glycidyl ether; monoepoxides of diene or polyene such as butadiene monoepoxide and chloroprene monoepoxide; alkenyl monoepoxides such as 3,4-epoxy-1-butene and 1,2-epoxy-5-hexene; and glycidyl esters of an ethylenically unsaturated carboxylic acid such as glycidyl acrylate and glycidyl methacrylate. Of these, halogenated alkylene oxides and ethylenically unsaturated glycidyl ethers are preferable. Allyl glycidyl ether and epichlorohydrin are especially preferable. The crosslinking oxirane monomer (c) may be used either alone or as a combination of at least two kinds thereof.

A polymerization catalyst used for ring-opening polymerization of the above-recited oxirane monomers may be selected from those which are conventionally used. The polymerization catalyst includes, for example, organoaluminum compound-containing catalyst such as a catalyst prepared by reacting an organoaluminum compound with water and acetylacetone (Japanese Examined Patent Publication [hereinafter abbreviated to “JP-B”] S35-15797), a catalyst prepared by reacting triisobutylaluminum with phosphoric acid and triethylamine (JP-B S46-27534), and a catalyst prepared by reacting triisobutylaluminum with an organic acid salt of diazabicycloundecene, and phorphoric acid (JP-B S56-51171); organozinc compound-containing catalysts such as a catalyst comprised of a partially hydrogenated product of an aluminum alkoxide, and an organozinc compound (JP-B S43-2945), a catalyst comprised of an organozinc compound and a polyhydric alcohol (JP-B S45-7751), and a catalyst comprised of a dialkylzinc and water (JP-B S36-3394); organotin compound-containing catalysts such as a catalyst comprised of an organotin compound and a phosphoric acid ester compound (JP-B S46-41378); and alkali metal-containing catalysts such as potassium hydroxide and sodium methoxide.

Of the above-recited polymerization catalysts, organoaluminum compound-containing compounds and organotin compound-containing catalysts are preferable because formation of a crosslinked product can be suppressed. Organoaluminum compound-containing catalysts are more preferable. A catalyst prepared by reacting triisobutylaluminum with phosphoric acid and triethylamine is especially preferable. Organoaluminum compound-containing compounds and organotin compound-containing catalysts have a function of dehydrating agent and thus can suppress the formation of a crosslinked product. A catalyst prepared by reacting triisobutylaluminum with an organic acid salt of diazabicycloundecene, and phosphoric acid is also especially preferable because formation of a toluene-insoluble matter is minimized and thus a polyether polymer film having high strength can be obtained.

In the polymerization of oxirane monomers, a Lewis base compound having no active hydrogen is preferably added to a monomer mixture because the formation of a crosslinked product can be more markedly suppressed. As specific examples of the Lewis base compound having no active hydrogen, there can be mentioned nitrile compounds such as acetonitrile and benzonitrile; cyclic ether compounds such as tetrahydrofuran and dioxane; isocyanate compounds such as phenyl isocyanate; ester compounds such as methyl acetate, ethyl acetate, butyl acetate, methyl propionate and ethyl propionate; alkali metal alkoxide compounds such as potassium t-amyloxide; phosphine compounds such as triphenylphosphine; and sulfoxides such as dimethylsulfoxide. Of these, nitrile compounds, cyclic ether compounds and ester compounds are preferable. Acetonitrile, tetrahydrofuran, dioxane and ethyl acetate are more preferable. Acetonitrile is especially preferable. These Lewis base compounds may be used either alone or as a combination of at least two kinds thereof. The amount of Lewis base compound is usually in the range of 0.01% to 20% by weight, preferably 0.05% to 10% by weight, based on the total monomers.

A polymerization solvent used in the production of a polyether polymer or other water-absorbing polymers is selected from those which do not deactivate a polymerization catalyst. The polymerization solvent includes, for example, aromatic hydrocarbons such as benzene and toluene; aliphatic hydrocarbons such as n-pentane and n-hexane; and alicyclic hydrocarbons such as cyclopentane and cyclohexane. The amount of polymerization solvent is usually such that the monomer concentration is in the range of 1% t 50% by weight, preferably 10% to 30% by weight.

In the case when a water-absorbing polymer having a very low moisture content is produced, the monomers and the polymerization solvent are preferably dehydrated prior to the polymerization. The dehydration treatment includes, for example, an adsorption treatment using an adsorbent such as molecular sieve, silica gel or active alumina; and a water separation treatment such as distillation or azeotropic distillation. The total amount of water in the monomers and the polymerization solvent is preferably not larger than 0.04% by weight, more preferably not larger than 0.03% by weight, based on the total weight of monomers.

The polymerization procedure includes, for example, a solution polymerization procedure and a solvent slurry polymerization procedure. A solvent slurry polymerization procedure using a solvent such as n-pentane, n-hexane or cyclopentane is preferable.

The polymerization can be carried out at a temperature in the range of 0 to 100° C., preferably 30 to 70° C., and in any polymerization manner such as batchwise, semi-batchwise or continuous manner.

The polymerization is followed by a step of stopping the polymerization reaction by incorporating a polymerization stopper in a polymerization mixture, and further, a step of removing a polymerization solvent and recovering a water-absorbing polymer. In these steps, the content of water in a system with which the water-absorbing polymer is contacted, is controlled to usually not larger than 0.04% by weight, preferably not larger than 0.03% by weight, based on the weight of polymer. To control the water content of the contact system in such an amount, total amount of water contained in the additives and solvent which are used in the polymerization stopping step and succeeding step should also be controlled to not larger than 0.04% by weight based on the weight of polymer, and these steps should be carried out under conditions such that water is not incorporated from the environment into the contact system.

The polymerization stopper used in the polymerization stopping step includes, for example, alcohols, amines and fatty acids. Alcohols having 1 to 3 carbon atoms such as methanol, ethanol, n-propanol and isopropanol are preferable. Ethanol is especially preferable.

The polymerization stopper is preferably dehydrated prior to the addition to a polymerization mixture so that the moisture content is preferably not larger than 1,000 ppm by weight, more preferably not larger tan 700 ppm by weight. The dehydration treating procedure includes those which are mentioned above for the solvent and monomers used. The amount of polymerization stopper is usually in the range of 0.1 to 10 times by weight, preferably 0.2 to 5 times by weight, of the amount of catalyst. When the amount of polymerization stopper is too small, the polymerization reaction cannot be stopped completely, and side reactions such as crosslinking reaction tend to occur. In contrast, when the amount of polymerization stopper is too large, it is troublesome to dehydrate the stopper so as to decrease the amount of moisture in the stopper to a desired degree.

A solvent used for washing a recovered water-absorbing polymer is preferably dehydrated prior to the washing. The dehydration treatment can be carried out by a procedure similar to that for the above-mentioned polymerization solvent. The content of moisture in the washing solvent is preferably not larger than 20 ppm by weight, more preferably not larger than 10 ppm by weight.

The polymerization step is followed by the recovering step. In the recovering step, an antioxidant is preferably added prior to the removal of solvent. A conventional antioxidant may be used as the antioxidant as mentioned above.

The procedures for removal of solvent and drying of polymer are preferably carried out under conditions such that the polymer is not contacted with water, more specifically in a dry nitrogen or a dry air atmosphere, or under a reduced pressure. If these procedures are carried out in an ordinary air atmosphere, the water-absorbing polymer tends to absorb water and to give a crosslinked product. The air atmosphere in which these procedures are carried out usually has a moisture content of not larger than 2 g/m³, preferably not larger than 0.5 g/m³.

The procedure for removing the solvent from the water-absorbing polymer is not particularly limited. For example, in the case when the water-absorbing polymer is produced by a solvent slurry polymerization procedure, a procedure can be adopted wherein the polymer is recovered, for example, by filtration or centrifugal separation, and then, the polymer is dried, for example, by heating or under a reduced pressure to remove the solvent. In the case when a water-absorbing polymer is produced by a solution polymerization procedure, there can be adopted a direct drying procedure wherein the solvent is removed directly from the polymerization mixture (for example, by drying the polymerization mixture) after the polymerization stopping step, or a procedure wherein the polymerization mixture is put into a solvent incapable of dissolving the water-absorbing polymer, to thereby precipitate the water-absorbing polymer, and then, the polymer is recovered by the same procedure as mentioned above for the solvent slurry polymerization procedure.

The drying of the water-absorbing polymer can be carried out by using a spray dryer, a rotary dryer, a flash dryer, a fluidizing dryer, a vacuum dryer, and extrusion dryers such as a screw dryer and an expander dryer. These dryers may be used either alone or as a combination of at least two thereof.

The method for recovering the water-absorbing polymer preferably includes a method wherein a slurry of the water-absorbing polymer is filtered or subjected to centrifugal separation, and the separated polymer is vacuum dried to give polymer particles. In this recovering method, the following procedures can be adopted to avoid the contact of water-absorbing polymer with water: (i) a procedure wherein filtration or centrifugal separation, and vacuum drying are carried out in a dry chamber having an inner atmosphere of dry air, (ii) a procedure wherein a vessel having a water-absorbing polymer slurry therein is connected to a filter and a vacuum dryer whereby filtration and vacuum drying are effected in a closed system, and (iii) a procedure wherein solvent is removed by a continuous centrifugal separator and then the polymer is dried by a continuous paddle-type vacuum dryer whereby separation and vacuum drying are conducted in a closed system.

In the production process of the present invention, first, a finely divided particle of a water-absorbing polymer having a moisture content which is at least 300 ppm by weight lower than the moisture content (selected from the range of 300 to 50,000 ppm by weight) of the target polymer particle is prepared. The moisture content of the water-absorbing polymer particle to be treated by the process of the present invention is usually not larger than 10,000 ppm by weight, preferably in the range of 100 to 5,000 ppm by weight and more preferably 1,000 to 5,000 ppm by weight. If the moisture content of the water-absorbing polymer particle is not adjusted to this range by previously drying the polymer particle, it is very difficult or even impossible to produce, with an enhanced efficiency, the water-absorbing polymer particle having the desired moisture content with a reduced variability from lot to lot and suitable for a shaped article exhibiting good characteristics.

The water-absorbing polymer to be treated by the process of the present invention may be used either alone or as a combination of at least two kinds thereof. In the case when two or more kinds of water-absorbing polymers are used in combination, a water-absorbing polymer having the largest moisture content among the two or more kinds of polymers must be adjusted so that it has a moisture content which is at least 300 ppm by weight lower than the moisture content (selected from the range of 300 to 50,000 ppm by weight) of the target polymer particle.

The water-absorbing polymer particle has an average particle diameter in the range of 10 to 2,000 μm, preferably 100 to 1,000 μm and especially preferably 200 to 600 μm. The shape of the polymer particle is not particularly limited.

In the process of the present invention, the moisture content of a water-absorbing polymer particle having the above-mentioned moisture content is increased by 300 ppm by weight or more to a moisture content in the range of 300 ppm to 50,000 ppm by weight. The increase of the moisture content is carried out by one of the following two processes (1) and (2).

(1) A water-absorbing polymer particle is brought into contact with a stream of air having a moisture content in the range of 2 to 20 g/m³ in a closed vessel (this process is hereinafter referred to as “first process”).

(2) A pressurized air having a moisture content in the range of 2 to 20 g/m³ is fed under pressure into a transportation chamber of a pneumatic transportation apparatus where a water-absorbing polymer particle is brought into contact with a stream of the pressurized air while the polymer particle is transported through the transportation chamber (this process is hereinafter referred to as “second process”).

An apparatus used in the first process includes, for example, a dryer equipped with a paddle stirrer, a fluidized bed dryer, a fluidized bed reservoir and a vibrating fluidized bed dryer. An apparatus used in the second process is a pneumatic transportation apparatus having a transportation chamber through which a water-absorbing polymer particle is transported by a stream of pressurized air. In the second process, a water-absorbing polymer particle, as produced by polymerization and then recovered and dried, is usually reserved temporarily in a first reservoir; then the polymer particle is transported from the first reservoir through the pneumatic transportation apparatus to a second reservoir for reserving the polymer particle. In the second process, transportation of the water-absorbing polymer particle and moisture-control of the polymer particle can be conducted simultaneously. Thus, the second process is carried out with an enhanced productivity. After the moisture content-controlled polymer particle is transported into the second reservoir, a pressurized air having a moisture content in the range of 2 to 20 g/m³ is preferably fed into the second reservoir.

An air having a moisture content in the range of 2 to 20 g/m³, preferably 5 to 15 g/m³ is fed into a vessel or chamber for the moisture control of the water-absorbing polymer particle in the first and second processes, although a suitable moisture content in the air varies depending upon the moisture content of the water-absorbing polymer particle and the moisture content of the target polymer particle. If the moisture content in the air is too small, a water-absorbing polymer particle having a desired moisture content cannot be obtained, or can be obtained only with low efficiency. In contrast, the moisture content in the air is too large, a water-absorbing polymer particle having a desired moisture content having a reduced variability from lot to lot is difficult or even impossible to obtain. Especially in the case when a strongly water-absorbing polymer particle is used, if the moisture content in the air is too large, the polymer particle easily absorbs too large amount of water and exhibits enhanced stickiness, and thus, a water-absorbing polymer particle having a desirably controlled moisture content cannot be obtained.

The flow rate of air to be fed per kg of a water-absorbing polymer particle in the first process is preferably in the range of 0.01 to 0.2 Nm³/kg·hr, more preferably 0.02 to 0.1 Nm³/kg·hr. The flow rate of pressurized air to be fed in the second process is such that the ratio (S/G) of a transportation rate (S: kg/hr) of a water-absorbing polymer particle to a flow rate (G: kg/hr) of pressurized air to be fed is preferably in the range of 1.0 to 5.0, more preferably 2.0 to 4.0. By controlling the flow rate of air in these ranges, the effect of the present invention is more enhanced.

The pressurized air is fed under an absolute pressure of preferably 110 to 1,000 kPa, more preferably 120 to 600 kPa and especially preferably 130 to 300 kPa.

In the second process, the pneumatic transportation of a water-absorbing polymer particle is conducted preferably by a pulse transportation system whereby the amount of air required for transporting the polymer particle can be reduced. By the term “pulse transportation system” as used herein, we mean a system wherein the water-absorbing polymer particle is transported intermittently. More specifically a cycle of pneumatically transporting the polymer particle within a predetermined period of time and then stopping the pneumatic transportation of polymer for a predetermined time is repeated.

In the pulse transportation system, the cycle time is preferably in the range of 5 to 200 seconds, more preferably 20 to 150 seconds and especially preferably 50 to 110 seconds. The time for transporting the polymer particle within one cycle is preferably in the range of 1 to 100 seconds, more preferably 5 to 50 seconds and especially preferably 10 to 30 seconds. The time for stopping the transportation of the polymer particle within one cycle is preferably in the range of 1 to 199 seconds, more preferably 10 to 150 seconds and especially preferably 30 to 100 seconds. When the cycle time, the transporting time and the stopping time are in the above-specified ranges, the amount of air required for transportation of the polymer particle can be minimized.

In the case when the pneumatic transportation of the polymer particle is carried out by a pulse transportation system, the transportation rate (S: kg/hr) of the polymer particle for the calculation of the above-mentioned ratio (S/G) means an average transportation rate per unit time within a cycle time. Similarly, the flow rate (G: kg/hr) of the pressurized air for the calculation of the ratio (S/G) means an average flow rate per unit time within a cycle time.

The water-absorbing polymer particle obtained by the process of the present invention has a moisture content in the range of 300 to 50,000 ppm by weight, preferably 1,000 to 20,000 ppm by weight. If the moisture content of polymer particle is too small, the variability of moisture content from lot to lot is large. In contrast, if the moisture content of polymer particle is large, the variability from lot to lot is large, and the polymer particle tends to exhibit a large stickiness and have poor handling characteristics.

The water-absorbing polymer particle having the controlled moisture content, produced by the process of the present invention, is usually used as a shaping material. According to the need, additives such as an antioxidant, a light stabilizer, a lubricant, a fire retardant, a mildew-proofing agent, an antistatic agent, a colorant, a reinforcing agent and a filler are added to the shaping material.

The antioxidant used is not particularly limited, and conventional antioxidants may be used, which include, for example, phenolic antioxidants, thiophenolic antioxidants and organic phosphite antioxidants. Of these, phenolic antioxidants are preferable. Hindered phenolic antioxidants are especially preferable. The amount of an antioxidant is usually in the range of 0.001 to 3% by weight based on the total oxirane monomer units.

### EXAMPLES

The invention will now be specifically described by the following examples and comparative examples. Parts in these examples are by weight unless otherwise specified.

In the following examples and comparative examples, experiments were carried out with an aim of producing a water-absorbing polymer having a moisture content of 6,000±1,000 ppm by weight.

### Example 1

(Preparation of Polyether Polymer)

An autoclave equipped with a stirrer was charged with 65.1 parts of triisibutylaluminum, 217.9 parts of toluene and 121.6 parts of diethyl ether. The temperature of the content was set at 30° C., and, while the content was stirred, 11.26 parts of phosphoric acid was added at a constant rate over a period of 10 minutes. Further 4.97 parts of triethylamine was added. Then a reaction for ripening was carried out at 60° C. for 2 hours to give a catalyst solution.

Another autoclave equipped with a stirrer was charged with 1,514 parts of n-hexane and 63.3 parts of the above-mentioned catalyst solution. The temperature of the content was set at 30° C., and, while the content was stirred, 7.4 parts of ethylene oxide was added and a reaction was carried out. Then 14.7 parts of a monomer mixture comprising the same amounts of ethylene oxide and propylene oxide was added to carry out a reaction for preparing a seed-containing polymerization liquid.

The temperature of the seed-containing polymerization liquid within the autoclave was set at 60° C. To the seed-containing polymerization liquid, a liquid mixture comprised of 439.6 parts (92% by mole) of ethylene oxide, 50.4 parts (8% by mole) of propylene oxide and 427.4 parts of n-hexane was continuously added at a constant rate over a period of 5 hours. After completion of the addition, a reaction was continued for 2 hours. The polymerization conversion was 98%. To a thus-produced polymer slurry, 42.4 parts of a 4,4′-thiobis-(6-tert-butyl-3-methylphenol) solution having a concentration of 5% by weight in toluene was added with stirring. A thus-produced polymer crumb was filtered and dried under vacuum at 40° C. to give a polymer of finely divided particulate form.

The thus-obtained polyether polymer particle had an average particle diameter of 430 μm. Analysis of the polyether polymer by H-NMR and C¹³—NMR at 500 MHz revealed that the polymer was comprised of 91.5% by mole of ethylene oxide (EO) units and 8.5% by mole of propylene oxide (PO) units. The weight average molecular weight (Mw) of the polymer and the molecular weight distribution [ratio of Mw/Mn (number average molecular weight) of the polymer were 350,000 and 10.2, respectively, as measured by gel permeation chromatography (GPC) and expressed in terms of standard polystyrene.

The moisture content of the polyether polymer was 1,400 ppm by weight. This moisture content of the polymer was measured as follows. The moisture content in a solution of the polyether polymer in toluene was measured by Karl-Fischer moisture content-measuring apparatus. A moisture content of the toluene solvent as blank was deducted from the measured moisture content of the polymer solution. Then the moisture content of the polymer was calculated from the obtained moisture content taking account of the concentration of the polymer solution in toluene.

(Treatment for Controlling Moisture Content of Polymer)

Treatment for controlling the moisture content of the polyether polymer was carried out with an aim of producing a water-absorbing polymer having a moisture content of 6,000±1,000 ppm by weight.

The finely divided polyether polymer particle having an average particle diameter of 430 μm was placed in a transportation chamber of a pneumatic transportation apparatus. A pressurized air having a moisture content of 12.8 g/m³ was fed under an absolute pressure of 150 kPa into the transportation chamber whereby the finely divided polymer particle was pneumatically transported to a hopper located 30 m apart and at a height of 3 m. The pneumatic transportation of polymer particle was conducted by a pulse transportation system. The cycle time was 90 seconds. The transporting time was 25 seconds and the transportation stopping time was 65 seconds. The transportation rate of polymer upon transportation was 1,100 kg/hr, and the average transportation rate (S) within a cycle time was 300 kg/hr. The average flow rate of pressurized air was 93.8 kg/hr and thus, the S/G ratio was 3.2. A sample of the polyether polymer particle transported into the hopper was taken in a manner such that the polymer particle is not contacted with air, and the moisture content thereof was measured. The moisture content was 6,300 ppm by weight.

### Comparative Example 1

The procedures for moisture content-controlling treatment of the polyether polymer as described in Example 1 was repeated wherein the air having a moisture content of 25.2 g/m³ was fed into the transportation chamber of the pneumatic transportation apparatus instead of a pressurized air having a moisture content of 12.8 g/m³. All other conditions remained the same. The moisture content of polymer particle was increased from 1,400 ppm to 60,000 ppm by weight. That is, the moisture content exceeded to a great extent the target value (6,000 ppm±1,000 ppm by weight).

### Example 2

A polyether polymer particle having an average particle diameter of 430 μm and a moisture content of 1,400 ppm by weight was prepared by the same procedures as described in Example 1.

Using the polyether polymer particle, a treatment for controlling the moisture content was carried out as follows. 12 kg of the polymer particle was placed in a dryer equipped with a paddle stirrer (capacity: 40 liters, supplied by Chuo-Kakoki K.K.). An air having a moisture content of 9.31 g/m³ was fed at a flow rate of 0.46 m³/hr while the polymer particle was agitated by the stirrer for 30 minutes.

A sample of the moisture-controlled polyether polymer particle was taken in a manner such that the polymer particle is not contacted with air, and the moisture content thereof was measured. The moisture content was 6,000 ppm by weight.

The water-absorbing polymer produced by the process of the present invention has a desirably controlled moisture content which exhibits a reduced variability from lot to lot and is suitable for exhibiting good characteristics for various uses of shaped articles thereof. The polymer has good processability, and good handling characteristics at processing and shaping steps.

When a finely divided particle of a polyether polymer comprising as the principal structural ingredient oxyalkene repeating units formed by ring-opening polymerization of at least one oxirane monomer is subjected to a moisture content-controlling treatment according to the process of the present invention, a polyether polymer having a volume resistivity varying from lot to lot only to a minimized extent, and exhibiting reduced stickiness at handling can be produced. The polyether polymer is especially suitable for an OA roll.

1. A process for producing a water-absorbing polymer having a controlled moisture content, characterized in that a finely divided particle of a water-absorbing polymer is brought into contact with a stream of air having a moisture content in the range of 2 to 20 g/m³ in a closed vessel so that the moisture content in the finely divided particle of polymer is increased by 300 ppm by weight or more to a moisture content in the range of 300 ppm to 50,000 ppm by weight.

2. The process for producing a water-absorbing polymer according to claim 1, wherein the stream of air is fed in an amount in the range of 0.01 t 0.2 Nm³/hr per kg of the finely divided particle of polymer.

3. The process for producing a water-absorbing polymer according to claim 1, wherein the moisture content in the finely divided particle of polymer is increased by 1,000 ppm by weight or more to a moisture content in the range of 2,000 ppm to 10,000 ppm by the contact with the stream of air.

4. The process for producing a water-absorbing polymer according to claim 1, wherein the water-absorbing polymer is a polyether polymer comprising as the principal structural ingredient oxyalkene repeating units formed by ring-opening polymerization of at least one oxirane monomer.

5. A process for producing a water-absorbing polymer having a controlled moisture content, characterized in that a pressurized air having a moisture content in the range of 2 to 20 g/m³ is fed into a transportation chamber of a pneumatic transportation apparatus where a finely divided particle of a water-absorbing polymer is brought into contact with a stream of the pressurized air while the finely divided particle of polymer is transported through the transportation chamber, so that the moisture content in the finely divided particle of polymer is increased by 300 ppm by weight or more to a moisture content in the range of 300 ppm to 50,000 ppm by weight.

6. The process for producing a water-absorbing polymer according to claim 5, wherein the ratio (S/G) of the transportation rate (S [kg/hr]) of the finely divided particle of a water-absorbing polymer to the flow rate (G [kg/hr]) of the pressurized air fed is in the range of 1.0 to 5.0.

7. The process for producing a water-absorbing polymer according to claim 5, wherein the transportation of the finely divided particle of polymer is carried out by a pulse transportation system.

8. The process for producing a water-absorbing polymer according to claim 5, wherein the moisture content in the finely divided particle of polymer is increased by 1,000 ppm by weight or more to a moisture content in the range of 2,000 ppm to 10,000 ppm by the contact with the stream of air.

9. The process for producing a water-absorbing polymer according to claim 5, wherein the water-absorbing polymer is a polyether polymer comprising as the principal structural ingredient oxyalkene repeating units formed by ring-opening polymerization of at least one oxirane monomer.

10. A process for producing a water-absorbing polymer having a controlled moisture content, characterized in that a finely divided particle of a water-absorbing polymer is dried to a moisture content which is at least 300 ppm by weight lower than a finally desired moisture content within the range of 300 ppm to 50,000 ppm by weight; and then, the dried finely divided particle of polymer is brought into contact with a stream of air having a moisture content in the range of 2 to 20 g/m³ so that the moisture content in the finely divided particle of polymer is increased by 300 ppm by weight or more to the finally desired moisture content within the range of 300 ppm to 50,000 ppm by weight.
